(19) United States
(12) Patent Application Publication
(10) Pub. No.: US 2017/0310800 A1
(43) Pub. Date: Oct. 26, 2017

(54) MULTIFUNCTIONAL WEARABLE APPARATUS

(71) Applicant: John Edward Giust, San Diego, CA (US)

(72) Inventor: Giust Edward John, San Diego, CA (US)

(21) Appl. No.: 15/495,047

(22) Filed: Apr. 24, 2017

Related U.S. Application Data
(60) Provisional application No. 62/326,926, filed on Apr. 25, 2016.

(51) Int. Cl. H04M 1/02; A44C 15/00; H04M 1/21; A41D 1/00; H04M 1/00

(52) U.S. Cl. CPC H04M 1/0283; H04M 1/21; A41D 1/005; A44C 15/00; H04M 1/00

(57) ABSTRACT

The invention consists of a multifunctional wearable. In addition to functioning as wearable jewelry, the invention contains a wire or cable to provide an additional function, such as for carrying audio signals or digital data. Thus a wearable can be used, for example, as a headphone cable or data cable, or to provide additional functions.

### CLAIM FOR PRIORITY

This application claims priority from provisional application No. 62/326,926, entitled “Multifunctional Necklace or Jewelry Apparatus,” filed on Apr. 25, 2016, which is incorporated herein by reference in its entirety.

### BACKGROUND OF THE INVENTION

This invention relates to a new wearable, a form of fashion jewelry which combines fashion and electronic communications.

### DESCRIPTION OF THE PRIOR ART

Necklaces and jewelry are known in the prior art to provide a decorative and stylish appearance on the wearer. What is needed is improved utility for such jewelry, as well as additional ways for one to show style and personality.

Typically utilitarian “braiding” such as TECHFLEX is used for audio cables to protect the cable. The braiding or sleeving is available in different colors or a UV reactive style which may glow in the dark in certain circumstances.

### BRIEF DESCRIPTION OF THE INVENTION

The invention is an improved “wearable”/necklace or item of jewelry which contains an audio, data or other cable, or electronics. This provides a useful wearable item which is also decorative.

### BRIEF DESCRIPTION OF THE DRAWINGS

FIG. 1 depicts an audio player/headphone setup of the prior art.

FIG. 2 depicts a person wearing an inventive wearable described herein.

FIG. 3 shows the construction of a wearable of the present invention partial cut-away view.

FIG. 4 shows an assembled wearable of the present invention in a partial cut-away view.

FIG. 5 shows a person using a wearable of the present invention with an audio player.

FIG. 6 shows an audio player that may form a portion of the invention.

FIG. 7 shows a multifunctional wearable containing a wearable processor in a partial cut-away view.

FIG. 8 and FIG. 9 show a multifunctional wearable for a dual entry headphone in a partial cut-away view.

FIG. 10 shows a wearable with a clasp.

FIG. 11 shows a wearable with ferromagnetic coupling and USB data connections.

### DETAILED DESCRIPTION OF THE INVENTION

The invention presents a wearable item of jewelry which contains useful and functional features, in addition to its aesthetic properties.

For example, many headphones have detachable cables. The invention may be thought of as a necklace or in some embodiments as “headphone jewelry,” (meaning a fashion headphone cable). Recently the term “wearable” has been used to describe something that can be worn, but which also has additional utility. The invention herein is both a necklace that can be worn (on the neck or other areas of a person such as wrist/ankle, etc. . . . ) and also a cable with audio or data utility, and is thus referred to as a “wearable” herein.

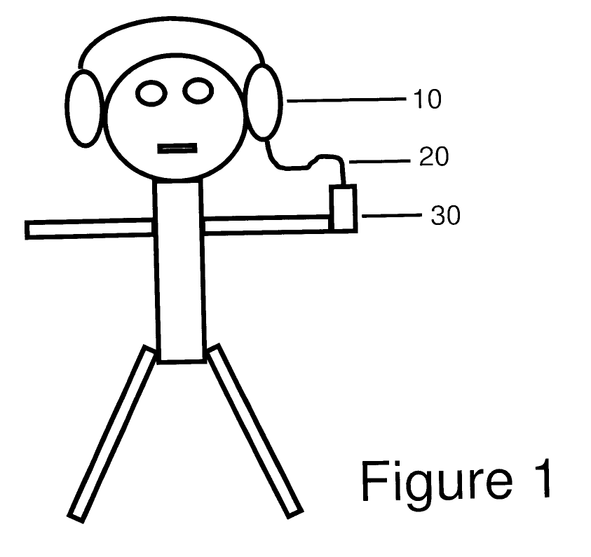

FIG. 1 shows a system of the prior art, depicting a person holding an audio player 10, which may be an iPad™, iPhone™ Android smartphone, or other audio player. Cable 20 connects the audio player to a set of headphones 30.

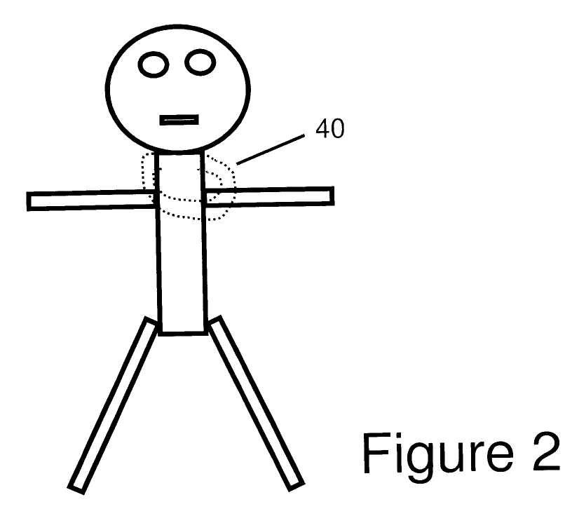

FIG. 2 shows an embodiment of the invention. As shown, a person is shown wearing a necklace or wearable 40. The necklace/wearable 40 is an item of jewelry with unique multifunctional capability not shown in FIG. 2 but described herein and shown in the additional figures. While wearable 40 is shown around the neck of the person in FIG. 2, it may be worn around other body parts such as the wrist or waist, or merely draped on the person as a fashion accessory.

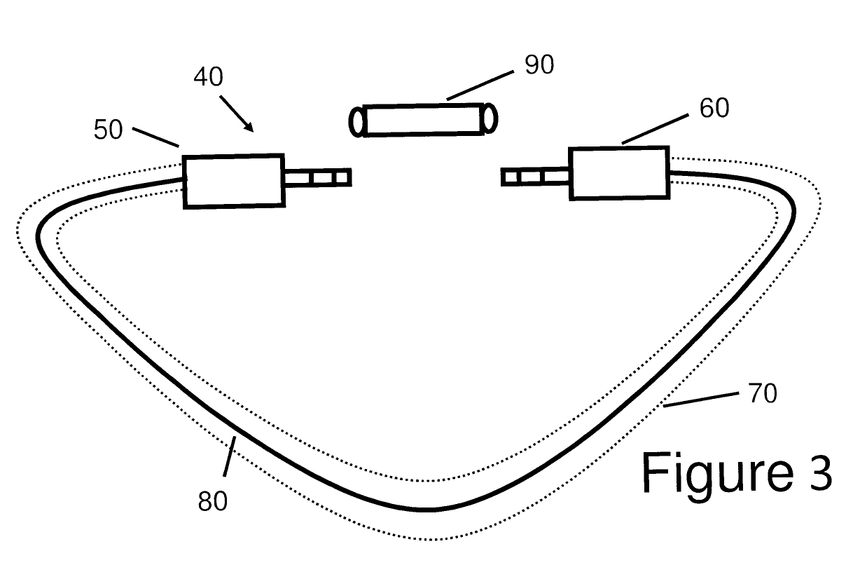

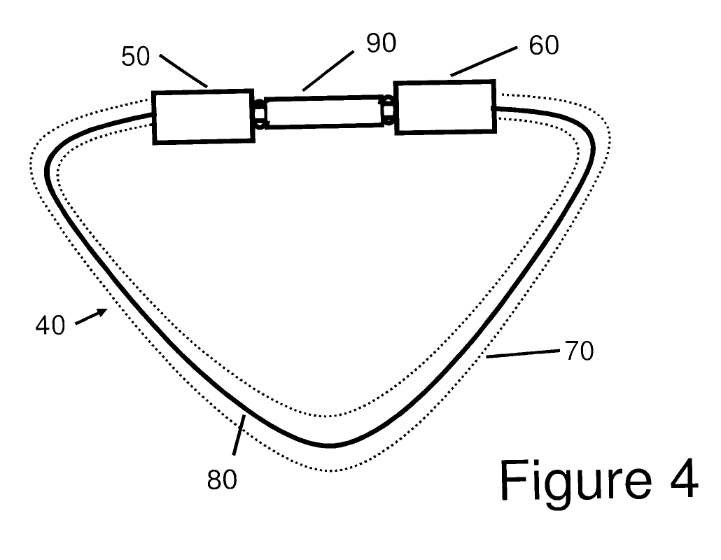

FIG. 3 depicts one embodiment of necklace/wearable 40. In this embodiment, the decorative wearable contains a 3.5 mm TRS (tip-ring-sleeve) audio connection 50 (or other connection such as ¼″ or XLR) for insertion into an audio player and/or smartphone 10. The other end may contain a headphone connector 60 for connection to a headphone. The outer surface of necklace/wearable 40 is a hollow chain 70 made of gold/silver or other precious metal (or other jewelry type finish or structure). In this embodiment chain 70 is hollow, and a multiconductor cable 80 is disposed within the inner part of the chain 70, shown as partial cut-away in FIG. 3, functionally connecting audio player connector 50 to headphone connector 60. In the partial cut-away view of FIG. 3 (and FIGS. 4, 7, 8 and 9), multiconductor cable 80 is shown within chain 70 but would not be easily visible to a viewer in normal circumstances.

The headphone connector 60 may be a 3.5 mm TRS connector (identical or similar to connector 50) as many headphones use such a connector, including certain models of BEATS headphones sold by Apple Computer Inc., of Cupertino Calif. USA. If the connector 60 does not mate with the connector 50 (as in the case depicted in FIG. 3), a coupler 90 may be used which mates the two ends of the cable together.

FIG. 4 shows the coupler 90 fastening the ends connectors 50 and 60 together to make a necklace type wearable. The partial cut away view of FIG. 4 shows the internal multiconductor cable 80 although it is not readily visible to a user. Note that the multiconductor cable 80 herein need not be a solid unitary cable but could consist of the necessary number of wires all run together.

The coupler may be a Monoprice 107230 3.5 mm stereo jack to 3.5 mm stereo jack adapter, available from Amazon.com (Amazon Standard Identification Number (“ASIN”) B004C87WQ6 or B01DV0LTEQ) or model 7230 available at Monoprice.com. The coupler need not couple the electrical signals from the cable but is there to physically connect the connectors 50 and 60 together to that the wearable does not fall off when worn. The Coupler could be a bracket or a plastic/poly sleeve that couples the ends or any other part of the wearable if necessary. It could be a magnetic or ferromagnetic material in the case where the wearable contained magnets or ferromagnetic material along its length. Likewise a coupler may not be necessary if one end of the wearable contained a magnet and the other a ferromagnetic material so that the ends or near-ends were sufficiently attracted to each other to fasten physically. Hook and loop material or other mechanical fastening structures could also replace the coupler 90.

In most audio players and cellular devices having a 3.5 mm TRS connection, the tip is the left channel signal, the ring is the right channel signal and the sleeve is shared ground between left and right. In most headphones using a single entry 3.5 mm TRS jack, such as BEATS wired headphones, the connections are the same. Thus multiconductor cable 80 of FIG. 3 would connect the Tip, Ring, and Sleeve of both ends 50/60 to one another and allow an audio signal from a smartphone, for example to be heard in a compatible headphone, such as a BEATS wired headphone.

As stated previously, some headphones (such as wired BEATs models) use 3.5 mm TRS (tip-ring sleeve) connectors at the headphone end (60) which are similar to connectors used for audio players. Other headphones use a 3.5 mm TRRS (tip-ring-ring-sleeve) connector, and others use pins or coaxial connectors (such a the MMCX connector for in-ear-monitors (IEMs)). Still others use 2.5 mm TRS or mono connectors (in each ear-cup known as “dual entry” headphones). Depending on the type of source connector 50 and headset connector 60, coupler 90 is constructed to mate the two to make the wearable able to be worn around the neck (or other part such as a wrist or waist or ankle) of a person. Various balanced audio connectors such as TRRS and “penta” type (used by Sony), among others may also be used at either connector 50, 60

Thus necklace/wearable 40 has a multifunctional ability of being used both as a necklace and as an audio (headphone) cable. One assembled wearable/necklace is shown in FIG. 4 with coupler 90 holding the ends in place. Depending on its construction, this necklace may be indistinguishable from prior art jewelry but contain within it additional functionality as described herein.

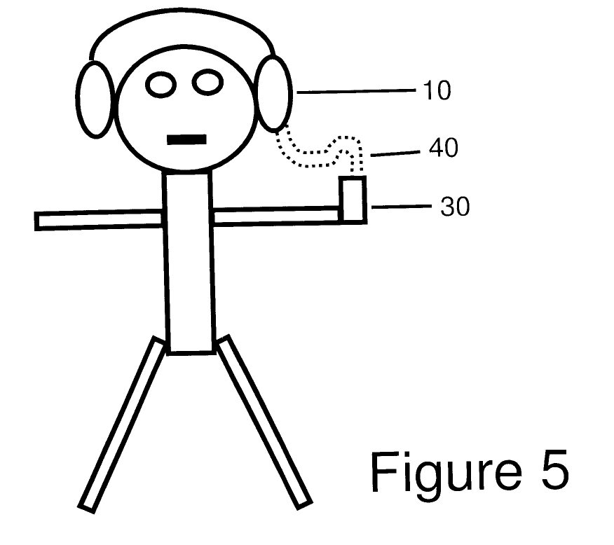

In fact, as shown in FIG. 5, it is desired that the necklace/wearable is able to be removed from use around the neck of the user so it can also be utilized as a decorative audio (or other) cable, connecting player 10 to headset 30. This multifunction necklace is an improvement over prior art necklaces lacking such capability. The embodiment of FIG. 5, (lacking a separate connected coupler) depicts a necklace 40 used as an audio player cable. Thus the term “necklace” and “wearable” herein is intended to cover the cable 40 with coupler 90 installed as shown in FIG. 4, and without coupler 90 installed as shown in FIG. 5, whether it be worn as a necklace around a person's neck or around another part of the body.

In addition, rather than headphones, other audio devices using cables may incorporate the present invention. Thus cables for musical instruments, microphones, interconnects, speakers, digital audio or other devices may incorporate the invention. These use commonly available connectors (¼″ TRS, ¼″ TS (tip-sleeve), XLR and mini or tiny XLR, RCA, fiber, spade, banana, Speak-on etc. . . . ) and utilize one or more physical cables that may be disposed within a hollow jewelry like structure.

There are many variations possible to impart additional or separate utility to wearable 40. For example, wearable 40 may be a data cable rather than an audio cable. In such a case player end 50 may be a male USB connection to a storage medium and headset end 60 may be a similar male USB connection to a personal computer. In this case coupler 90 is a Female-to-Female USB coupler. These couplers are commonly available, one example is “Cable Matters (2 Pack) Gold-Plated SuperSpeed USB 3.0 Female Coupler” available on Amazon.com, ASIN number B00J4NMTMQ.

In this case, multifunctional wearable 40 has the additional useful feature of being able to carry computer data.

In some embodiments the outer portion 70 of the necklace 40 may be a hollow mesh chain of silver and/or gold surrounding an inner cable, shown as a partial cut-away view in FIGS. 3, 4, 6, 7, 8 and 9. The cable, present inside the hollow chain, conducts electrical signals from one end to the other. In fact, if the hollow chain is made of a conductor such as silver or gold, it may be operatively connected to the grounded audio signal to provide shielding from noise. Typically the Sleeve on a TRS connector represents the negative signal or ground, which may be operatively connected to one or both ends of the chain 70, if the chain 70 is conductive. It has been found that the chain 70 should preferable not conduct signals from one end to the other for at least two reasons, even though the systems works if constructed this way. First, the chain will short portions of itself out if it touches itself which might be audible during use. Second, it has been observed that the physical metallurgical makeup of chain 70 could adversely affect sound quality, if for example, the chain 70 was only partially conductive or poorly conductive.

The invention is not a colored or sleeved cable but rises to the level of jewelry and fashion. The outer portion 70 of the invention is preferably made of a semiprecious or precious metal rather than colored nylon or plastic. While 70 is referred to as a “chain” herein, it can be any decorative structure that can contain a wire or wires, or which wire or wires may pass through. It can contain jewels or other rare and valuable objects having no use for the function of the cable 80 disposed within or through but designed to be visually pleasing. In fact the wearable 40 can be configured with so many items irrelevant to the function of carrying an audio or data signal that it is not recognized as an audio or data cable at all.

The coupler 90 can be decorative jewelry as well (matching or not with the outer portion 70).

If the audio player is an android or other smartphone, an application or media player “skin” can be provided that mimics or is complementary with the jewelry. In addition a “push to talk” button and/or microphone can be located anywhere on the wearable 40, if desired.

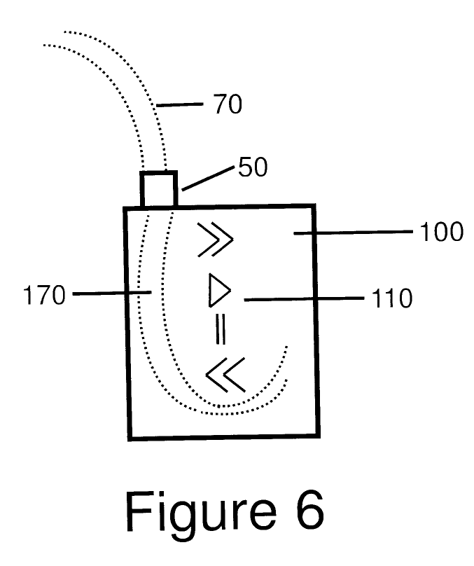

FIG. 6 shows a media player or “skin” that complements the outer surface 70 of wearable 40 connected at player end 50 to a media player or smart phone 100. As shown in FIG. 6, an Android smartphone 100 runs a media player application 110 having controls for playing media such as play, pause next song, prior song (shown by standard icons, unnumbered). The media player, as is known, may also display a background image. In the present invention this background image 170 matches the appearance of the outer portion of the wearable 70 (partially shown at only the player end in FIG. 6), giving the visual appearance that the wearable 70 extends into the android smartphone. For example, if the 70 is a gold chain, the application or image can be loaded automatically or manually when the necklace is inserted into a smartphone or player to show a similar gold chain 170 as an image on the player. The app could display the gold chain 170 on the screen of the smartphone, for example a loop of jewelry 170 that appears to exit the smartphone at the location where the audio connection exists.

Alternatively, the app or skin could show the chain entering the screen and being connected to a still or animated audio cassette, CD or record (showing that music is playing). Alternatively the application or skin would show the brand name/trademark or other identifying insignia of the manufacturer of the necklace (or an advertisement).

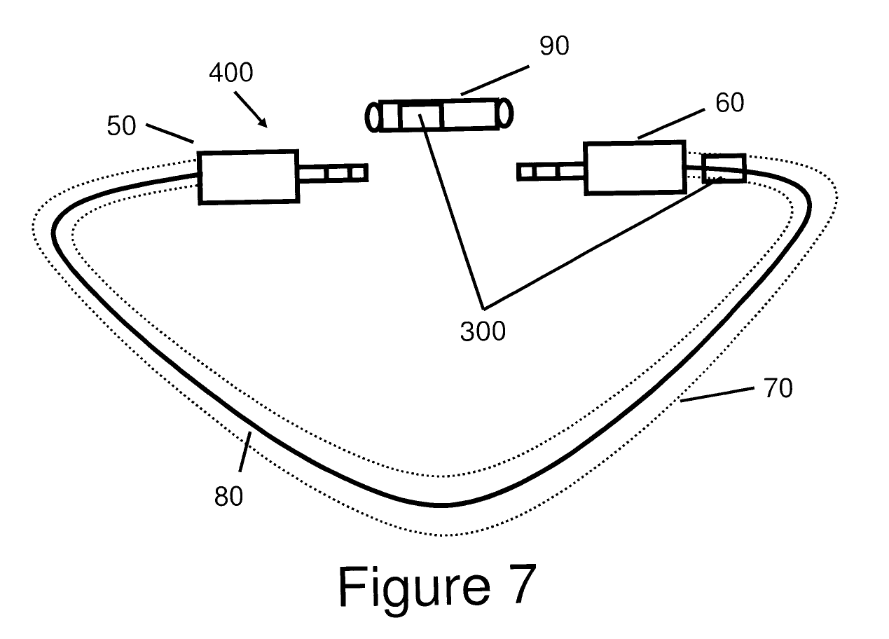

FIG. 7 shows a further embodiment. In FIG. 7, wearable 400 contains an outer decorative layer 70 described previously (shown with multiconductor cable 80 in a partial cut away view), with an embedded “wearable processor” 300 at one position. Wearable processor 300 could be a fitness monitor touching the skin of the user, or in communication with a sensor that monitor's aspects of the user's health. In such a case the wearble 400 may contain standard clasps 210 and 220 rather than a coupler 90. However, a coupler 90 could still be used. In such a case the wearable processor may be disposed in the coupler instead of the wearable 400 (or alternatively could still be within the wearable 400).

Wearable processors are known in the industry and for example may be similar to the Nike FitBit™ or other fitness trackers, or glucose or other health monitors. Such wearable processors/devices are disclosed, for example in U.S. Pat. No. 7,003,335 issued Feb. 21, 2006 and incorporated herein by reference in its entirety. Additional wearable processors may be media players or WIFI or Bluetooth media players.

The wearable of the present invention can take many forms and have many wires. For example, sometimes headphones are “dual entry”, meaning a individual wires connect to the left and right earcups. An example of such a headphone are the HiFiMan® HE400s, Sennheiser HD800 and most in-ear-monitors (IEMs).

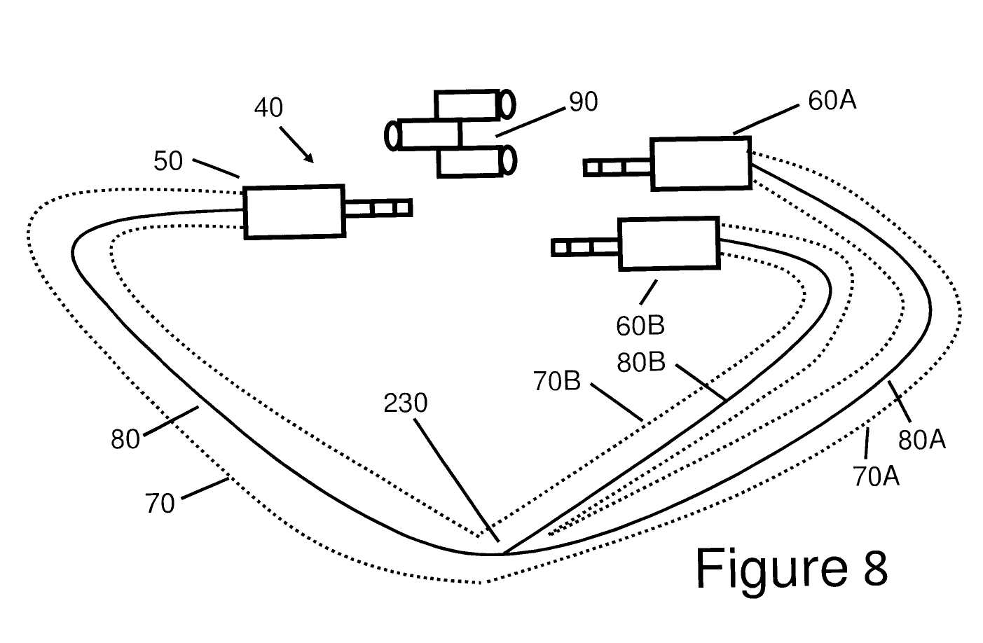

FIG. 8 shows a wearable 40 with an outer decorative layer 70 in a partial cut away view showing internal cables 80, 80A and 80B. However in this case there are two headphone connectors, 60A and 60B, one 60A for the left earcup on the headphones and one 60B for the right earcup on the headphones. The other layer of jewelry 70 extends to a “Y” neckline split 230 where the cables diverge to the left and right earcups. The outer layer 70 may extend to the left and right earcups as shown by 70A and 70B, or may end at the Y connection 230. In this case, with respect to the HiFiMan HE400s dual entry headphone (and most dual entry headphones) the tip/left audio signal of connector 50 is connected to the tip of the left earcup 60A and the sleeve/ground of 50 is connected to the sieve of 60A. The ring/right audio signal of 50 is connected to the tip of 60B, and the sleeve of 50 is additionally connected to the sleeve of 60B. Each earcup of a dual entry headphone typically uses the tip and sleeve connector with sleeve for ground, but it may vary according to brand.

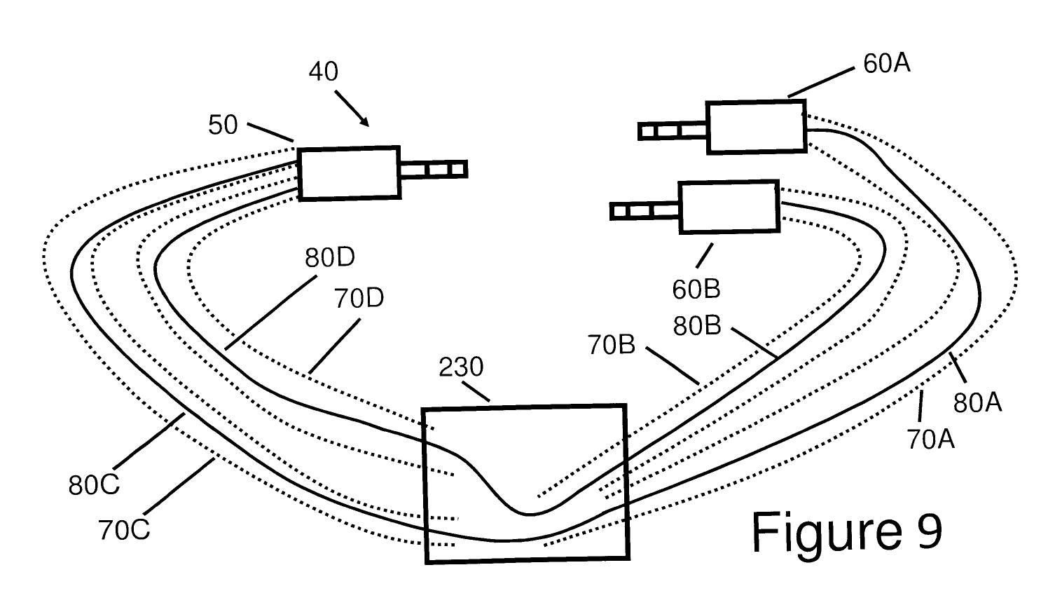

Alternatively, FIG. 9 shows a similar arrangement where the necklace is symmetrical in a partial cut away view showing internal cables 80A, 80B, 80C and 80D. As shown, the wire 80 prior to the neckline Y breakout 230 is made to be two cables 80C and 80D instead of one 80, along with two lines of Jewelry 70C and 70D. This gives the necklace symmetry and preserves the ability to carry audio signals. The Y split 230 may itself be decorative. Alternatively only one of 70C and 70D could contain an internal multiconductor cable 80, and the other would be hollow or empty. The coupler 90 of FIG. 8 could be used with the system of FIG. 9, if necessary.

The wearable can be continuous through the split 230, thus using two sections of jewelry, or the jewelry can terminate within the split 230 (as shown), using 4 sections of jewelry, along with other variations.

Suitable wearables of the present invention have been constructed using multiconductor cables, 3.5 mm TRS connectors and mesh chains of gold and silver, for example. The gold and silver chains can have a 5 mm or 6 mm outer diameter which leaves a sufficient inside diameter suitable to fit many multiconductor cables within. Suitable 3.5 mm TRS connectors with a 5 or 6 mm entry diameter to accept such a chain are available, including the KS3PC series of connectors (with rubber grommet removed) sold by the Amphenol corporation of Wallingford, Conn., USA. In an assembled wearable the internal cable 80 is well hidden though it may be partially visible depending on its color and the chain 70 color or finish (for example a black cable within a silver mesh chain is easier seen than a black cable within a black link chain of the same construction).

Thus as shown in FIGS. 8 and 9 a multifunctional necklace 40 could be used as a dual entry headphone cable where connectors 60A and 60B connect to headphones to feed them an audio signal from connector 50 that attaches to an audio source. The necklace 40 may also contain a wearable processor, or other functional device.

Coupler 90 is not required. For example, the necklace could be sufficiently resilient such that it could be worn without coupler 90 and not fall off a person's neck.

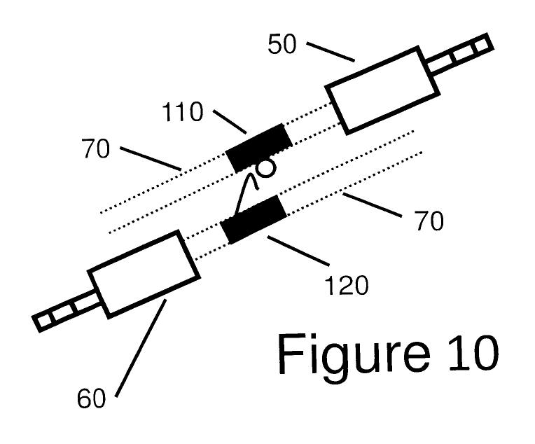

FIG. 10 shows an example where the decorative portion of the chain 70 contains a clasp 110 and fastener 120 so that the cable 70 may be fastened to itself at 110/120 without a coupler when the ends 50 and 60 are looped close to one another. FIG. 10 is only a partial view showing the ends 50 and 60 and how those regions would connect to one another.

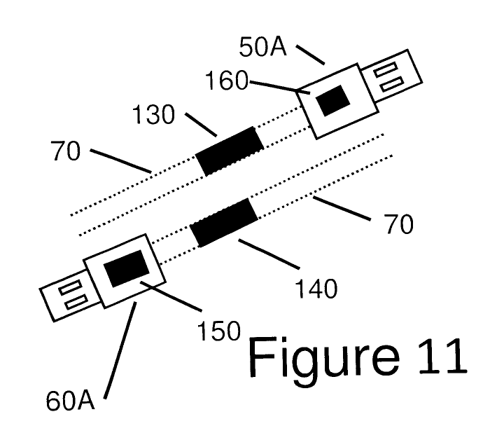

FIG. 11 shows an example were USB connectors 50A and 60A are used instead of audio connectors. In this example, chain 70 contains ferromagnetic and/or magnetic materials on one end at either or both 130/160 and at the other end at 140 and/or 150, such that the chain 70 when wound around a hand, neck, foot or other body part will physically retain its position and not unwind or fall off. Of course these types of connectors could be used in the invention depicted in the other figures instead of a coupler 90 or clasp 100/fastener 120. FIG. 11 is only a partial view showing the ends 50A and 60A and how those regions would connect to one another.

In the case where the outer decorative layer 70 is a link chain or other construction, the multiconductor cable 80 may be woven in an out of the links or attached to the decoratively layer inconspicuously rather than hidden in an internal cavity. Audio or data cables may contain very thin wire that is easily hidden or only partially visible. Just because chain 70 is referenced as a “chain” does not mean that need be formed for links to embody a chain type structure. It may be any decorative/jewelry type tube, decoration or structure.

To assemble the necklace, the inner cable 80 may be drawn or pushed through the hollow jewelry layer 70. Once the cable is through, the audio or data connectors are soldered, crimped or otherwise attached. The ends where layer 70 meets connectors 50 and 60 may be finished with heat shrink which may be adhesive lined. The finishing may include other standard jewelry techniques.

The above description is not intended to be limiting, as many variations and embodiments are possible. For example, while the invention can be a multifunctional wearable or necklace, it may also be described as a jewelry-like audio or data cable that is both functional and visually appealing. Various aspects of the figures can be combined with one another to form variations of the invention. The invention is only limited by the claims attached hereto.

1. A wearable comprised of:
an outer jewelry surface which contains a hollow cavity
a multi-conductor cable within the hollow cavity
a headphone connector on one end of the multi-conductor cable
an audio player connector on the other end of the multi-conductor cable.

2. The wearable of claim 1 further comprising a coupler to physically connect the headphone connector to the audio player connector, such that the wearable may be worn around the head of a person.

3. The wearable of claim 1 wherein the headphone connector is a 3.5 mm tip-ring-sleeve male connector, and wherein the audio player connector is also a 3.5 mm tip-ring-sleeve male connector.

4. The wearable of claim 3 wherein the outer jewelry surface is metallic and conductive, and wherein the sleeve of the audio player connector is electrically connected to the jewelry surface, but the jewelry surface is otherwise electrically insulated from the headphone connector.

5. A wearable comprised of:
an outer jewelry surface which contains a hollow cavity
a multi-conductor data cable within the hollow cavity
a USB data connector on one end of the multi-conductor cable
a USB data connector on the other end of the multi-conductor cable.

6. A headphone cable, comprising
an outer surface having a metallic jewelry like finish, which contains a hollow cavity
a multi-conductor cable within the hollow cavity
a headphone connector on one end of the multi-conductor cable
an audio player connector on the other end of the multi-conductor cable.
